(19) United States
(12) Patent Application Publication
(10) Pub. No.: US 2002/0107323 A1
(43) Pub. Date: Aug. 8, 2002

(54) Styrenic polymer compositions with improved clarity

(76) Inventors: Andre J. Uzee, Baton Rouge, LA (US); L. Frank Wright JR., Houston, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/933,420

(22) Filed: Aug. 20, 2001

Related U.S. Application Data
(60) Provisional application No. 60/233,289, filed on Sep. 15, 2000.

(51) Int. Cl. C08L 53/00

(52) U.S. Cl. 525/95

(57) ABSTRACT

Disclosed is a transparent polymeric blend, which is readily recyclable several times without any significant deterioration in clarity or transparency of articles produced therefrom, comprising:

A) from 9 to 90 parts by weight, preferably from 15 to 75 parts by weight, of a monovinyl aromatic-conjugated dine copolymer having a weight average molecular weight (Mw) from 50,000 to 400,000;

B) from 9 to 90 parts by weight, preferably from 15 to 75 parts by weight, of a monovinylidene aromatic polymer having a weight average molecular weight (Mw) from 50,000 to 400,000; and

C) from 1 to 60 parts by weight, preferably from 2 to 50 parts by weight, more preferably from 3 to 40 parts by weight, of a styrene-isoprene-styrene triblock copolymer having a weight average molecular weight of from about 40,000 to about 150,000 wherein the styrene content is from about 25 to 60 weight percent of the total polymer, and the sum of A), B) and C) being 100 parts. Also disclosed are shaped articles made from such blend and process for preparing such articles.

### CROSS REFERENCE STATEMENT

This application claims the benefit of U.S. Provisional Application No. 60/233,289, filed Sep. 15, 2000.

### FIELD OF THE INVENTION

This invention relates to transparent styrenic polymer compositions having improved clarity after being exposed to repeated heat history associated with the fabrication and processing thereof, to articles made therefrom, and to methods of the preparation therefor. More particularly, this invention relates to transparent ternary polymeric blends containing styrenic block copolymers with isoprene midblocks.

### BACKGROUND OF THE INVENTION

Styrenic thermoplastic polymer compositions have been used commercially for fabricating numerous articles for different end-use applications for a number of years. The fabricating steps for these articles such as sheets, films, foams, and other molded objects involve heating, melting, shaping, and cooling of the thermoplastic compositions. Each passage of a thermoplastic polymer composition through a typical fabricating machine, such as an extruder or an injection molding machine, represent a “heat history” for such composition. Although an absolutely essential component of converting the polymer compositions to useful articles, each heat history has a generally adverse impact on certain desired physical properties of such compositions. The adverse impact is generally cumulative with each additional heat history.

Multiple heat history, with discernable deterioration of the desired physical properties in converted articles, are introduced to a polymer composition by re-using of the waste or scrap material or recycling of post-consumption articles in conjunction with new or virgin compositions in the interest of energy conservation and environmental protection. These re-use and recycle practices are a routine part of various polymer processing operations.

In ternary blends containing styrenic block copolymers with butadiene midblocks, repeated processing often leads to crosslinking which results in reduced clarity (because of increased haze) of the articles fabricated from such blends. The increase in haze often renders the fabricated articles hazy rather than clear or see-through. The crosslinking is affected by the heat input during the processing of such blends, and thereby limits the temperature at which such blends can be processed.

Therefore, there is a continuing need for transparent ternary polymeric blends containing styrenic block copolymers which blends can maintain the desired clarity (i.e., low haze values) thereof throughout multiple heat history experienced during the processing and recycling of such blends.

### SUMMARY OF THE INVENTION

One aspect of the present invention is a transparent polymer blend, which is readily recyclable several times without any significant deterioration in clarity or haze of articles produced therefrom, comprising:

A) from 9 to 90 parts by weight, preferably from 15 to 75 parts by weight, of a monovinyl aromatic-conjugated diene copolymer having a weight average molecular weight (Mw) from 50,000 to 400,000;

B) from 9 to 90 parts by weight, preferably from 15 to 75 parts by weight, of a monovinylidene aromatic polymer having a weight average molecular weight (Mw) from 50,000 to 400,000; and

C) from 1 to 60 parts by weight, preferably from 2 to 50 parts by weight, more preferably from 3 to 40 parts by weight, of a styrene-isoprene-styrene triblock copolymer having a weight average molecular weight of from about 40,000 to about 150,000 wherein the styrene content is from about 25 to 60 weight percent of the total polymer, and the sum of A), B) and C) being 100 parts.

Another aspect of the present invention is a process for preparing a transparent polymeric article, such as sheet or film, which comprises

A) contacting a virgin polymer blend with a recycled polymer blend to form a homogeneous blend wherein the polymer blends independently comprise (1) from 9 to 90 parts by weight, preferably from 15 to 75 parts by weight, of a monovinyl aromatic-conjugated diene copolymer having a weight average molecular weight (Mw) from 50,000 to 400,000 (2) from 9 to 90 parts by weight, preferably from 15 to 75 parts by weight, of a monovinylidene aromatic polymer having a weight average molecular weight (Mw) from 50,000 to 400,000; and (3) from 1 to 60 parts by weight, preferably from 2 to 50 parts by weight, more preferably from 3 to 40 parts by weight, of a styrene-isoprene-styrene triblock copolymer having a weight average molecular weight of from about 40,000 to about 150,000 wherein the styrene content is from about 25 to 60 weight percent of the total polymer, and the sum of A), B) and C) being 100 parts.;

B) forming an article from the combined composition; and

C) recycling scrap material generated during the step of forming the article or subsequent processing steps;

wherein the recycled composition contains polymer blend which has been recycled at least five times; and the percent haze value of the combined composition is within 25 percent, as determined pursuant to ASTM D1003 of the virgin polymer blend.

An additional aspect of the present invention is a process for preparing a transparent polymeric article, such as sheet or film, which comprises:

A) forming an article from a recycled composition comprising (1) from 9 to 90 parts by weight, preferably from 15 to 75 parts by weight, of a monovinyl aromatic-conjugated diene copolymer having a weight average molecular weight (Mw) from 50,000 to 400,000 (2) from 9 to 90 parts by weight, preferably from 15 to 75 parts by weight, of a monovinylidene aromatic polymer having a weight average molecular weight (Mw) from 50,000 to 400,000; and (3) from 1 to 60 parts by weight, preferably from 2 to 50 parts by weight, more preferably from 3 to 40 parts by weight, of a styrene-isoprene-styrene triblock copolymer having a weight average molecular weight of from about 40,000 to about 150,000 wherein the styrene content is from about 25 to 60 weight percent of the total polymer, and the sum of A), B) and C) being 100 parts.;

B) recycling scrap material generated during the step of forming the article or subsequent processing steps;

wherein the recycled composition contains polymer blend which has been recycled at least five times; and the percent haze value of the combined composition is within 25 percent, as determined pursuant to ASTM D1003 of the virgin polymer blend.

Yet another aspect of the present invention is a transparent polymeric article prepared by the process which comprises:

A) contacting a virgin polymer blend described herein before with a recycled polymer blend described herein before to form a homogeneous blend;

B) forming an article from the combined composition; and

C) recycling scrap material generated during the step of forming the article or subsequent processing steps;

wherein the virgin polymer blend and the recycled polymer blend comprise

a) from 9 to 90 parts by weight, preferably from 15 to 75 parts by weight, of a monovinyl aromatic-conjugated diene copolymer having a weight average molecular weight (Mw) from 50,000 to 400,000;

b) from 9 to 90 parts by weight, preferably from 15 to 75 parts by weight, of a monovinylidene aromatic polymer having a weight average molecular weight (Mw) from 50,000 to 400,000; and

c) from 1 to 60 parts by weight, preferably from 2 to 50 parts by weight, more preferably from 3 to 40 parts by weight, of a styrene-isoprene-styrene triblock copolymer having a weight average molecular weight of from about 40,000 to about 150,000 wherein the styrene content is from about 25 to 60 weight percent of the total polymer, and the sum of A), B) and C) being 100 parts;

wherein the recycled composition contains polymer blend which has been recycled at least five times; and the percent haze value of the combined composition is within 25 percent, as determined pursuant to ASTM D1003 of the virgin polymer blend.

### DESCRIPTION OF FIGURES

FIG. 1 is a graph of the Melt Flow Rate of two blends, one containing a styrene-butadiene-styrene triblock copolymer (SBS-1) and one containing a styrene-isoprene-styrene triblock copolymer (SIS-1) versus the number of passes through an extruder.

FIG. 2 is a graph of the percent Haze of two blends, one containing a styrene-butadiene-styrene triblock copolymer (SBS-1) and one containing a styrene-isoprene-styrene triblock copolymer (SIS-1) versus the number of passes through an extruder.

FIG. 3 is a graph of the percent Transparency of two blends, one containing a styrene-butadiene-styrene triblock copolymer (SBS-1) and one containing styrene-isoprene-styrene triblock copolymer (SIS-1) versus the number of passes through an extruder.

### DETAILED DESCRIPTION OF THE INVENTION

The monovinyl aromatic-conjugated diene copolymers useful in the polymer blend of this invention are transparent resinous block copolymers having a weight average molecular weight (Mw) from 50,000 to 400,000 and which are usually derived from a monovinyl substituted aromatic compound and a conjugated diene. These include such block copolymers as the types AB, ABA, tapered AB and ABA and copolymer with varying degrees of coupling including branched or radial (AB)n and (ABA)n copolymers, where A represents a polymerized monovinyl aromatic compound and B represents a polymerized conjugated diene, and “n” is a whole number greater than 2. Other resinous block copolymers with different sequences of A and B blocks are also contemplated as useful in the present invention.

The resinous A blocks could be polymerized styrene, alpha-methylstyrene, 4-methylstyrene, 3-methylstyrene, 2-methylstyrene, 4-ethylstyrene, 3-ethylstyrene, 2-ethylstyrene, 4-tertbutylstyrene, 2,4-dimethylstyrene and condensed aromatics such as vinyl napthalene and mixtures thereof. The A blocks could be random or tapered monovinyl aromatic/conjugated diene copolymers. Presently preferred is styrene. The rubbery B block could be polybutadiene, polypentadiene, a random or tapered monovinyl aromatic/conjugated diene copolymer, polyisoprene, a random or tapered monovinyl aromatic-isoprene copolymer, or mixtures thereof. Presently preferred is butadiene and/or isoprene.

For the polymer blend of the present invention, styrene-butadiene block copolymers having a Shore D hardness as measured by ASTM D2240-86 of about 50 or higher, more preferably from about 64 to about 80, are presently preferred. These copolymers have a major amount of polymerized monovinyl aromatic compound, have resinous properties, and contain from about 50 to about 95 weight percent polymerized monovinyl aromatic, more preferably from about 65 to about 90 weight percent, and most preferably from about 70 to about 85 weight percent polymerized monovinyl aromatic, based on total weight of the copolymer. The remainder of the block copolymer is polymerized conjugated diene. They are prepared so that at least a portion of the final product is of a coupled character, linear or branched or both linear and branched.

It is generally desired that the melt flow of the monovinyl aromatic-conjugated diene copolymer be in the range from about 2 g/10 min., as determined pursuant to ASTM D1238 at 200° C. under a load of 5 kg, to about 15 g/10 min. Above about 50 g/10 min. the physical properties are not suitable. Below about 2 g/10 min. the melt flow is so low that processability is decreased, melt flow drop-off increases and good mixing is more difficult to achieve.

A single monovinyl aromatic-conjugated diene copolymer or mixtures of more than one monovinyl aromatic-conjugated diene copolymer are considered useful in this application of the invention.

Basic preparation of the useful monovinyl aromatic-conjugated diene block copolymers is disclosed in U.S. Pat. No. 2,975,160, the disclosure of which is hereby incorporated herein by reference.

The preferred block copolymers can be produced in accordance with U.S. Pat. Nos. 3,639,517 and 3,251,905, the disclosures of which are hereby incorporated herein by reference. More specifically, they can be prepared by sequential charge copolymerization in the presence of a randomizer using an initiator, such as for example, the methods described in U.S. Pat. Nos. 4,584,346, 4,091,053, 4,704,434 and 4,704, 435, the disclosures of which are hereby incorporated herein by reference.

Presently preferred for the polymer blend of the present invention are those monovinyl aromatic-conjugated diene copolymers having a refractive index in the range from about 1.520 to about 1.590, more preferably in the range from about 1.560 to about 1.580, and most preferably from about 1.565 to about 1.575. One such presently preferred styrene-butadiene copolymer is commercially available from Phillips Petroleum Company as K-Resin® polymer. Other related copolymers and methods of producing the same are disclosed in U.S. Pat. Nos. 4,086,298, 4,167,545, 4,335,221, 4,418,180, 4,180,530, 4,221,884, 4,346,198, 4,248,980, 4,248,981, 4,248,982, 4,248,983, and 4,248,984, the disclosures of which are hereby incorporated by reference.

Monovinylidene aromatic polymers are produced by polymerizing vinyl aromatic monomers such as those described in U.S. Pat. Nos. 4,666,987, 4,572,819 and 4,585,825, which are herein incorporated by reference. Preferably, the vinyl aromatic monomer is of the formula:

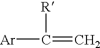

wherein R′ is hydrogen or methyl, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl, wherein alkylphenyl refers to an alkyl substituted phenyl group, with phenyl being most preferred. Typical vinyl aromatic monomers which can be used include: styrene, alpha-methylstyrene, all isomers of vinyl toluene, especially paravinyltoluene, all isomers of ethyl styrene, propyl styrene, vinyl biphenyl, vinyl naphthalene, vinyl anthracene and the like, and mixtures thereof.

The monovinylidene aromatic polymers used in the blend of the present invention has a typical molecular weight (Mw) of from 190,000 to 400,000 and a melt flow rate from 0.2 to 8 g/10 min. Typically the molecular weight is from 250,000, preferably from 270,000, more preferably from 275,000 and most preferably from 280,000 to 400,000, preferably to 375,000, more preferably to 350,000 and most preferably to 305,000. The melt flow rate is typically less than 8, preferably less than 4, more preferably less than 3, and most preferably less than 2 g/10 min. A preferred monovinylidene aromatic polymer is general purpose polystyrene which is commercially available from The Dow Chemical Company as STYRON® polystyrene.

As used herein the molecular weight (Mw) of various polymeric components refers to weight average molecular weight as measured by size-exclusion gel permeation chromatography using a polystyrene standard, which measurement is widely recognized among those skilled in the art. Commercially available polystyrene standards were used for calibration and the molecular weights of styrene-isoprene and styrene-butadiene block copolymers were corrected according to Runyon et al., J. Applied Polymer Science, Vol. 13, p. 2359 (1969) and Tung, L. H., J. Applied Polymer Science, Vol. 24, p. 953 (1979).

A key component of the transparent polymeric blends of the present invention is a styrene-isoprene-styrene triblock copolymer containing 25 percent by weight to 60 percent by weight styrene, preferably 25 to 55, and more preferably 30 to 50 percent by weight styrene. Such triblock copolymers are well known in the art and are commercially available from Dexco Polymers, a Dow/ExxonMobil Partnership, as VECTOR® copolymers.

In one embodiment, the preferred styrene-isoprene-styrene block copolymer has a molecular weight of from 40,000 to about 150,000, and more preferably of from 50,000 to about 125,000, with a styrene content of from about 25 percent by weight to 50 percent by weight, and more preferably from about 30 percent by weight to 50 percent by weight. Optionally, up to about 50 percent by weight of a styrene-butadiene-styrene block copolymer having a weight average molecular weight of from about 50,000 to about 100,000 and from about 25 to about 50 percent by weight of styrene may be blended with the styrene-isoprene-styrene triblock copolymer. Preferably, the transparent polymeric blend contains 40 percent by weight or less of styrene-butadiene-styrene triblock polymer blended with the styrene-isoprene-styrene triblock copolymer. Most preferably, the transparent styrene-isoprene-styrene component contains a styrene-isoprene-styrene triblock copolymer and does not contain a styrene-butadiene-styrene block copolymer. The presence of too much of the styrene-butadiene-styrene triblock polymer may result in untoward crosslinking which may cause untoward increases in percent haze.

Preferably, the styrene-isoprene-styrene triblock copolymer has a weight average molecular weight of about 40,000 or greater, more preferably about 45,000, even more preferably about 50,000 or greater and most preferably 60,000 or greater. Preferably, the styrene-isoprene-styrene triblock copolymers have a weight average molecular weight of about 150,000 or less, more preferably 135,000 or less and most preferably about 120,000 or less.

Another preferred styrene-isoprene-styrene triblock copolymer contains from 40 to 65 weight percent styrene and 35 to 60 weight percent isoprene and which has a weight averaged molecular weight (Mw) of about 89,000 and a number average molecular weight (Mn) of about 86,000. These and other block copolymers suitable for use herein will typically have a fairly narrow molecular weight distribution, with the Mw:Mn ratio thereof typically being in the range of from 1.0 to 1.3 (preferably from 1.0 to 1.2 and more preferably from 1.0 to 1.1).

A styrene-isoprene-styrene triblock copolymer of the present invention has a Tg less than 0° C., preferably less than −20° C.

It will be readily appreciated by the skilled artisan that additional polymer components may be incorporated into the present blend, if desired, without departing from the scope of the present invention, so long as the desired objectives disclosed herein are not lost.

In order to form articles from the polymer blends or compositions of this invention, the polymer blends are subjected to conditions which render them processable. Preferably, the polymer blends are converted to a form such that they have a melt flow rate which is suitable for the processing technique used to form articles from the polymer blends. In the embodiment where films or sheets are formed by extrusion, the polymer blends preferably have a melt flow rate of 0.1 grams per 10 min. or greater, as determined pursuant to ASTM D1238 at 200° C. under a load of 5 kg, more preferably 1.0 g/10 minutes or greater and most preferably 2.0 g/10 minutes or greater. Preferably, the polymer blends have a melt flow rate of 20 g/10 minutes or less, more preferably 18 g/10 minutes or less and most preferably 16 g/10 minutes or less. Techniques useful for forming articles from the polymer blend of this invention are well known in the art. In one preferred embodiment, the polymer blends, after being processed to achieve a suitable melt flow rate, are extruded or co-extruded into a desired shape, such as a sheet, film, or injection molded article. Generally, processing the polymer blends to achieve the desired melt flow rate is performed by heating the material to a temperature at which the desired melt flow rate is achieved.

In another preferred embodiment, it has also been found to be advantageous to incorporate certain added thermal stabilizers (that is, beyond those that are conventionally employed in commercial versions of the individual polymer blend ingredients) within the subject polymer blend compositions. Thermal stabilizers which have been found to be particularly beneficial in this regard both individually and especially in combination with each other are hindered phenol stabilizers such as Irganox 1010 and phosphite stabilizers such as trisnonyl phenyl phosphite. The indicated hindered phenol stabilizers are preferably employed in an amount ranging from 0.1 to 0.5 (more preferably from 0.2 to 0.3) weight percent on a total composition weight basis. The phosphite stabilizers, on the other hand, are preferably used in an amount ranging from 0.4 to 1.1 (more preferably from 0.5 to 1.0) weight percent on a total composition weight basis. Most preferably, the indicated phosphite and hindered phenol stabilizers are used in combination with each other, with each of them being used in their above-stated, individual preferred concentration ranges.

In a further desirable feature of the present invention, scrap material resulting from the preparation of the thermoformable sheet or from thermoformed articles, or injection molded article such as edge material or sprues which is cut from the sheets or articles, may be readily remelted and included in the thermoplastic blend without adverse effect on polymer properties. In a further embodiment, it may be desirable to improve surface properties of the thermoformable sheet, particularly the gloss of such sheet, by lamination or co-extrusion of a high gloss film to the surface to be ultimately exposed. Suitable high gloss films include extruded polystyrene. These films may be laminated to the thermoformable sheet surface by heat sealing, use of adhesives, or by co-extrusion techniques.

An advantage to the use of the styrene-isoprene-styrene triblock copolymer of this invention is that the addition of substantial amounts of stabilizers is not required to prevent the degradation of the properties of a polymer blend containing recycled material.

“Virgin composition,” as used herein, refers to a blend as described and claimed herein which his not been used previously is a thermoforming process, such as foaming a sheet by an extrusion process.

“Recycled composition,” as used herein, refers to a blend as described and claimed herein which has been used previously in a thermoforming process, such as forming a sheet.

“Scrap,” as used herein, refers to material derived from the blends of the invention which have been subjected to thermoforming processes, such as sheet extrusion or subsequent processes, and which are not incorporated into the final sheet product derivative thereof.

“Sheet”, as used herein, refers to a coherent polymer layer formed from the blends of this invention.

The term “contains material recycled at least five times” means the combined blend or recycled blend has been subjected to a thermoforming or extrusion process as described herein at least five times. As scrap is incorporated into the combined blend, some of the scrap will have been previously recycled, some of it at least five times.

The scrap from the process of forming an article or subsequent processing is recycled and combined with virgin polymer blend to prepare a combined polymer blend composition. The combined polymer blend composition is useful in forming articles according to the process of this invention. The amount of recycled scrap polymer blend which may be incorporated into the combined polymer blend composition is that amount which does not negatively affect the properties of the final article. Preferably, the percent haze of the combined composition is within about 50 percent of the virgin polymer blend composition. More preferably the percent haze of the combined polymer blend composition is within 25 percent of the virgin polymer blend. Preferably, the combined polymer blend comprises 100 percent by weight or less of the recycled scrap polymer blend, more preferably 75 percent by weight or less and most preferably 50 percent by weight or less. Preferably, the combined polymer blend comprises one percent by weight or more of the recycled scrap polymer blend, more preferably five percent by weight or more and most preferably ten percent by weight or more. Preferably, the polymer blends of this invention are capable of being recycled from the article formation processes at least five times and, preferably, seven times, without deleteriously affecting the properties of the formed articles.

In one embodiment, the recycled scrap polymer blend is combined with virgin polymer blend. The combined polymer blend can then be subjected to the forming process. In this embodiment, a portion of the polymer blend can contain material which has been recycled multiple times. In order for the combined polymer blend to be processable, the portion which has been recycled several times must not negatively affect the properties of the blend or articles formed.

In another embodiment, the scrap may be recycled as feed in the absence of virgin polymer blend. In such embodiment, the recycled scrap is the feed to the article formation process.

In the embodiment wherein the polymer blend contains recycled scrap, the scrap from previous forming steps or subsequent steps is contacted with virgin polymer blend. The contacting can take place using standard techniques. The virgin polymer blend and scrap can be contacted and thereafter heated to the temperature at which they are molten and, alternatively, the scrap and virgin polymer blends may be individually heated to temperatures at which they are molten and the molten polymer blends can then be contacted.

The polymer blends of this invention can be processed under conditions which do not deleteriously affect the properties of the articles prepared from them. The blends are sensitive to the particular conditions used and the type of equipment used to process the blends. A particularly advantageous type of processing apparatus is an extruder equipped with a conventional single flighted single screw with a feed section and compression section of at least 6 flights. Preferably, the apparatus has flow passages which are designed to avoid having the blend get hung up in corners or sharp bends, has gentle compression sections and does not subject the blends to high shear. Preferably, for sheet extrusion, the die has a coat hanger design. The blends of the invention are sensitive to shear, temperature and residence time in processing equipment. Generally, increases in shear rate, residence time and/or temperature may negatively affect the processability of the blends and products prepared from them. Preferably, the polymer blends are processable at a temperature of 170° C. or greater, more preferably 180° C. or greater and most preferably 190° C. or greater. The upper limit on the temperature to which the blends can be heated is that temperature at which the melt flow rate is too high to process the blend or the temperature at which the stability of the polymers in the blend is deleteriously affected. Preferably the blend is processable at a temperature of 250° C. or less, more preferably 235° C. or less and most preferably at 220° C. or less. Preferably the residence time in the processing apparatus is from about 15 seconds to about 4 minutes. Preferably the blends are processable at a shear rate produced by a typical single-screw extruder running at 5 revolutions per minute (RPM) or greater more preferably 10 RPM or greater and most preferably 15 RPM or greater. Preferably, the blends are processable at a shear rate exerted at 400 revolutions per minute (RPM) or less, more preferably 300 RPM or less and most preferably 250 RPM or less. The parameters for processing discussed generally apply to equipment meeting the conditions described above and adjustments may need to be made for other equipment. A skilled process engineer is capable of adjusting the processing parameters of the blend based on the equipment used. Selection of the most extreme conditions described may result in less processability due to the sensitivity of the blend.

The polymer blends may be formed into films using standard processing techniques. Such standard techniques are described in the Encyclopedia of Polymer Science and Engineering Mark et al., Ed. 2nd edition, Volume 7, pp. 88-106, incorporated herein by reference.

Thermoformable sheets of the thermoplastic blend of the present invention are readily prepared utilizing techniques well known in the prior art. Suitably, the molten polymer blend prepared according to the previously described melt blending process, or prepared by re-melting and re-extruding pellets thereof, is forced through a die to form a thin sheet. The sheet is subsequently passed through a thermoforming process (optionally after reheating if the sheet has been cooled below the thermoforming temperature) wherein the desired shape is pressed into the hot, nearly molten sheet. A desirable temperature range for thermoforming is from 130° C. to 170° C. Suitable thermoforming techniques are well known to the skilled artisan and disclosed, for example, in the Encyclopedia of Polymer Science and Engineering, 2nd Ed., Wiley-Interscience, Vol. 16, 807-832 (1989).

Although the thermoformed articles prepared from the polymer blends according to the present invention may be employed in any application, such as in containers, toys, and profiles, they are desirably employed in the preparation of disposable food packaging products requiring good transparency and low haze properties.

Having described the invention, the following examples are provided as further illustrative and are not to be construed as limiting. Unless stated to the contrary, all parts and percentages art based on weight.

In the examples that follow, SBS-1 refers to VECTOR 6241, SIS-1 to VECTOR 4411 of Dexco Polymers, PS-1 to “Experimental General Purpose Polystyrene XU70262.08” of The Dow Chemical Company, SB-1 to “K-RESIN KR05” of Chevron/Phillips Chemical Company, SB-2 to “KRATON D1401P” of Shell Chemical Company and SB-3 to “STYROLUX 693D” of BASF Chemical Company,

### EXAMPLES 1-4

In this series of examples, two different products (K-RESIN KRO5 and General Purpose Polystyrene), known for their low haze and transparent properties, and blends of such products were evaluated. Each product was injection molded on a Mannesman Demag 100 ton molder equipped with a seven-cavity, ASTM-specified family mold. The dry blended products (i.e., examples 2 and 3) were prepared by mixing in a tumble blender prior to injection molding. The general injection molding conditions are shown in Table 1.

TABLE 1
Injection Molding Conditions

| PROPERTY | Injection |
|---|---|
| Zone 1, ° C. | 160 |
| Zone 2, ° C. | 175 |
| Zone 3, ° C. | 175 |
| Zone 4, ° C. | 175 |
| Die, ° C. | 175 |
| Melt Temp., ° C. | 210-230 |
| Screw Speed, Rpm's | 120 |
| Injection Speed, sec. | 1.4 |
| Pressure, MPa | 4.7-12.4* |
| Cycle Time, sec. | 45 |
| Mold Temp., ° C. | 45 |

*Die

Properties of the formed products included haze and transparency, vicat softening point, Rockwell hardness, specific gravity, melt flow rate, tensile strength, elongation at break, tensile modulus, flexural modulus, notched izod impact and deflection temperature. The haze and transparency values were determined with a Hunter Lab Tristimulus Colorimeter Model D25P-9 with glass test standard numbered 425 in accordance with ASTM Method D 1003-92. The physical properties of the resulting blends are set forth in Table 2 below and tested in accordance with the ASTM methods shown.

TABLE 2

| Blend Components | Example No. | | | | |
|---|---|---|---|---|---|
| (Wt. Percent) | 1 | 2 | 3 | 4 | |
| General Purpose | 100 | 40 | 20 | | |
| Polystyrene (PS-1) | | | | | |
| K-RESIN KR05 (SB-1) | | 60 | 80 | 100 | |
| Butadiene Rubber from | 0 | 15.0 | 20.0 | 25.0 | |
| K-RESIN KR05, Wt. % | | | | | |
| Total Rubber | 0 | 15.0 | 20.0 | 25.0 | |
| Optical Properties | | | | | Test Method |
| Haze, % (Sample | 0.5 | 1.5 | 1.3 | 1.6 | ASTM D1003 |
| Thickness 0.060 in.) | | | | | |
| Haze, % (Sample | 0.6 | 2.5 | 2.5 | 2.7 | ASTM D1003 |
| Thickness 0.100 in.) | | | | | |
| Transparency, % (Sample | 91.4 | 88.5 | 90.1 | 90.8 | ASTM D1003 |
| Thickness 0.060 in.) | | | | | |
| Transparency, % (Sample | 91.3 | 86.5 | 89.2 | 90.2 | ASTM D1003 |
| Thickness 0.100 in.) | | | | | |
| Physical Properties | | | | | |
| Vicat Softening Point, | 225 (107.2) | 214 (101.1) | 206 (96.7) | 193 (89.4) | ASTM D 1525 |
| ° F. (° C.) | | | | | |
| Rockwell Hardness “L | 103 | 26 | 17 | 11 | ASTM D 785 |
| Scale” | | | | | |
| Specific Gravity | 1.05 | 1.03 | 1.02 | 1.01 | ASTM D 792 |
| Injection Molded | | | | | |
| Properties | | | | | |
| Mechanical Properties | | | | | |
| Yield Tensile Strength, | NA | 5520 (38.1) | 4330 (29.9) | 3317 (22.9) | ASTM D 638 |
| psi (MPa) | | | | | |
| Ultimate Tensile Strength, | 5820 (40.1) | 4620 (31.9) | 3050 (21.0) | 2563 (17.7) | ASTM D 638 |
| psi (MPa) | | | | | |
| Ultimate Elongation, % | 1 | 4 | 249 | 279 | ASTM D 638 |
| Tensile Modulus, psi | 478,000 | 323,000 | 277,000 | 228,000 | ASTM D 638 |
| (MPa) | (3,296) | (2,227) | (1,910) | (1,572) | |
| Flexural Modulus, psi | 445,000 | 356,000 | 292,000 | 252,000 | ASTM D 790 |
| (MPa) | (3,068) | (2,455) | (2,013) | (1,738) | |
| Flexural Strength, psi | 9750 (67.2) | 9400 (64.8) | 6550 (45.2) | 4957 (34.2) | ASTM D 790 |
| (MPa) | | | | | |
| Notched Izod @ 73° F. | 0.4 (21.4) | 0.4 (21.4) | 0.4 (21.4) | 0.6 (21.4) | ASTM D 256 |
| (23° C.), | | | | | |
| ft-lb/in (J/m) | | | | | |
| Notched Izod @ 0° F. | 0.2 (10.7) | 0.3 (16.0) | 0.4 (21.4) | 0.4 (21.4) | ASTM D 790 |
| (−18° C.), ft-lb/in (J/m) | | | | | |
| Thermal Properties | | | | | |
| DTUL @ 264 psi, ° F. (° C.) | 185 (85.0) | 170 (76.7) | 156 (68.9) | 145 (62.8) | ASTM D 648 |

NA = Not Applicable

As can be seen from the results in Table 2, the general purpose polystyrene product shown in example 1 gives the best optical properties, lowest percent haze and highest transparency. The results for example 4 show the SB-1 product gives a higher percent haze, lower transparency, increased flexibility and a lower thermal resistance versus the general purpose polystyrene in example 1. The results for examples 2 and 3 show blends of PS-1 blended with SB-1 gives a higher percent haze, lower transparency, increased flexibility and a lower thermal resistance versus PS-1 and more similar to SB-1.

### EXAMPLES 5-9

In this series of examples, two different products (K-RESIN KRO5 and General Purpose Polystyrene), known for their low haze and transparent properties, and blends of such products with Dexco DPX 507. Each product was injection molded on a Mannesman Demag 100 ton molder equipped with a seven-cavity, ASTM-specified family mold. The dry blended products (i.e., examples 6 through 9) were prepared by mixing in a tumble blender prior to injection molding. The general injection molding conditions are shown in Table 1.

Properties of the formed products included haze and transparency. The haze and transparency values were determined with a Hunter Lab Tristimulus Colorimeter Model D25P-9 with glass test standard numbered 425 in accordance with ASTM Method DI 003-92. The haze and transparency properties of the resulting blends are set forth in Table 3 below.

TABLE 3

| Blend Components | Example No. | | | | |
|---|---|---|---|---|---|
| (Wt. Percent) | 5 | 6 | 7 | 8 | 9 |
| Dexco DPX 507 (SBS-1) | | | 2.2 | 4.4 | 8.8 |
| General Purpose Polystyrene (PS- | | 50.0 | 52.8 | 55.6 | 61.2 |
| 1) | | | | | |
| K-RESIN KR05 (SB-1) | 100.0 | 50.0 | 45.0 | 40.0 | 30.0 |
| Butadiene Rubber from SBS-1, | 0 | 0 | 1.25 | 2.5 | 5.0 |
| Wt. % | | | | | |
| Butadiene Rubber from SB-1, | 25 | 12.5 | 11.25 | 10.0 | 7.5 |
| Wt. % | | | | | |
| Total Rubber | 25 | 12.5 | 12.5 | 12.5 | 12.5 |
| Optical Properties | | | | | |
| Haze, % (Sample Thickness 0.060 | 1.7 | 2.5 | 3.8 | 6.6 | 17.1 |
| in.) | | | | | |
| Haze, % (Sample Thickness 0.100 | 2.3 | 3.8 | 5.9 | 10.2 | 25.7 |
| in.) | | | | | |
| Transparency, % (Sample | 91.2 | 87.0 | 85.3 | 82.4 | 74.7 |
| Thickness 0.060 in.) | | | | | |
| Transparency, % (Sample | 90.8 | 84.1 | 81.5 | 77.2 | 66.3 |
| Thickness 0.100 in.) | | | | | |

As can be seen from the results in Table 3, the SB-1 product shown in example 5 gives the best optical properties, lowest percent haze and highest transparency. The results for example 6 show the SB-1/PS-1 blend product gives a higher percent haze and lower transparency versus example 5. The results for examples 7, 8 and 9 show blends of PS-1/SB-1/SB S-1 to show increases in percent haze and decreases in percent transparency with reductions in the percent SB-1 at constant total rubber content versus example 6.

### EXAMPLES 10-14

In this series of examples, two different products (KRATON D 1401 P and General Purpose Polystyrene), known for their low haze and transparent properties are evaluated and in blends with DPX 507. Each product was injection molded on a Mannesman Demag 100 ton molder equipped with a seven-cavity, ASTM-specified family mold. The dry blended products (i.e., examples 2 and 3) were prepared by mixing in a tumble blender prior to injection molding. The general injection molding conditions are shown in Table 1.

Properties of the formed products included haze and transparency. The haze and transparency values were determined with a Hunter Lab Tristimulus Colorimeter Model D25P-9 with glass test standard numbered 425 in accordance with ASTM Method D1003-92. The haze and transparency properties of the resulting blends are set forth in Table 4 below.

TABLE 4

| Blend Components | Example No. | | | | |
|---|---|---|---|---|---|
| (Wt. Percent) | 10 | 11 | 12 | 13 | 14 |
| Dexco DPX 507 (SBS-1) | | | 2.2 | 4.4 | 8.8 |
| General Purpose Polystyrene (PS-1) | | 50.0 | 52.8 | 55.6 | 61.2 |
| Shell KRATON D1401P (SB-2) | 100.0 | 50.0 | 45.0 | 40.0 | 30.0 |
| Butadiene Rubber from SBS-1, | 0 | 0 | 1.25 | 2.5 | 5.0 |
| Wt. % | | | | | |
| Butadiene Rubber from SB-2, | 25 | 12.5 | 11.25 | 10.0 | 7.5 |
| Wt. % | | | | | |
| Total Rubber | 25 | 12.5 | 12.5 | 12.5 | 12.5 |
| Optical Properties | | | | | |
| Haze, % (Sample Thickness 0.060 | 1.4 | 1.4 | 2.0 | 3.3 | 9.2 |
| in.) | | | | | |
| Haze, % (Sample Thickness 0.100 | 2.0 | 2.2 | 3.2 | 5.5 | 13.2 |
| in.) | | | | | |
| Transparency, % (Sample | 90.8 | 89.1 | 88.2 | 86.6 | 80.8 |
| Thickness 0.060 in.) | | | | | |
| Transparency, % (Sample | 90.0 | 87.6 | 86.1 | 83.6 | 75.5 |
| Thickness 0.100 in.) | | | | | |

As can be seen from the results in Table 4, for this series of samples, the SB-2 product shown in example 10 gives the best optical properties, lowest percent haze and highest transparency. The results for example 11 show SB-2/PS-1 blend product gives a similar percent haze and transparency versus example 10. The results for examples 12, 13 and 14 show blends of PS-1/SB-2/SBS-1 to show increases in percent haze and decreases in percent transparency with reductions in the percent SB-2 at constant total rubber content versus example 11.

### EXAMPLES 15-19

In this series of examples, two different products (STYROLUX 693D and General Purpose Polystyrene), known for their low haze and transparent properties are evaluated and in blends with DPX 507. Each product was injection molded on a Mannesman Demag 100 ton molder equipped with a seven-cavity, ASTM-specified family mold. The dry blended products (i.e., examples 2 and 3) were prepared by mixing in a tumble blender prior to injection molding. The general injection molding conditions are shown in Table 1.

Properties of the formed products included haze and transparency. The haze and transparency values were determined with a Hunter Lab Tristimulus Colorimeter Model D25P-9 with glass test standard numbered 425 in accordance with ASTM Method D1003-92. The haze and transparency properties of the resulting blends are set forth in Table 5 below.

TABLE 5

| Blend Components | Example No. | | | | |
|---|---|---|---|---|---|
| (Wt. Percent) | 15 | 16 | 17 | 18 | 19 |
| Dexco DPX 507 (SBS-1) | | | 2.2 | 4.4 | 8.8 |
| General Purpose Polystyrene (PS-1) | | 50.0 | 52.8 | 55.6 | 61.2 |
| BASF STYROLUX 693 D (SB-3) | 100.0 | 50.0 | 45.0 | 40.0 | 30.0 |
| Butadiene Rubber from SBS-1, | 0 | 0 | 1.25 | 2.5 | 5.0 |
| Wt. % | | | | | |
| Butadiene Rubber from SB-3, Wt. % | 25 | 12.5 | 11.25 | 10.0 | 7.5 |
| Total Rubber | 25 | 12.5 | 12.5 | 12.5 | 12.5 |
| Optical Properties | | | | | |
| Haze, % (Sample Thickness 0.060 | 8.9 | 6.6 | 8.3 | 10.0 | 20.8 |
| in.) | | | | | |
| Haze, % (Sample Thickness 0.100 | 12.2 | 10.5 | 13.7 | 16.0 | 32.2 |
| in.) | | | | | |
| Transparency, % (Sample Thickness | 89.4 | 85.4 | 83.1 | 81.4 | 73.2 |
| 0.060 in.) | | | | | |
| Transparency, % (Sample Thickness | 88.1 | 81.1 | 77.4 | 74.8 | 63.1 |
| 0.100 in.) | | | | | |

As can be seen from the results in Table 5, for this series of samples, the SB-3 product shown in example 15 gives the highest percent transparency and the SB-3/PS-1 blend product shown in example 16 gives the lowest percent haze. The results for examples 17, 18 and 19 show blends of SB-3/PS-1/SBS-1 to show increases in percent haze and decreases in percent transparency with reductions in the percent SB-3 at constant total rubber content versus example 11.

### EXAMPLES 20-23

In this series of examples, two different products (STYROLUX 693D and General Purpose Polystyrene), known for their low haze and transparent properties are evaluated and in blends with DPX 507 and VECTOR 4411. Each product was injection molded on a Mannesman Demag 100 ton molder equipped with a seven-cavity, ASTM-specified family mold. The dry blended products (i.e., examples 2 and 3) were prepared by mixing in a tumble blender prior to injection molding. The general injection molding conditions are shown in Table 1.

Properties of the formed products included haze and transparency. The haze and transparency values were determined with a Hunter Lab Tristimulus Colorimeter Model D25P-9 with glass test standard numbered 425 in accordance with ASTM Method D1003-92.

Examples 20 and 22 show two different blends containing a styrene-butadiene-styrene block copolymer (SBS-1) at 4.4 and 22.4%.

Examples 21 and 23 show two different blends containing a styrene-isoprene-styrene block copolymer (SIS-1). SIS-1 is investigated here for its performance versus SBS-1. The haze and transparency properties of the resulting blends are set forth in Table 6 below.

TABLE 6

| Blend Components | Example No. | | | |
|---|---|---|---|---|
| (Wt. Percent) | 20 | 21 | 22 | 23 |
| Dexco DPX 507 (SBS-1) | 4.4 | | 22.4 | |
| VECTOR 4411 (SIS-1) | | 4.4 | | 22.4 |
| General Purpose Polystyrene (PS-1) | 45.7 | 45.7 | 27.6 | 27.6 |
| K-RESIN KR05 (SB-1) | 50 | 50 | 50 | 50 |
| Butadiene Rubber from SBS-1, Wt. % | 2.50 | 0 | 12.5 | 0 |
| Isoprene Rubber from SIS-1, Wt. % | 0 | 2.50 | 0 | 12.5 |
| Butadiene Rubber from SB-1, Wt. % | 12.50 | 12.50 | 12.5 | 12.5 |
| Total Rubber | 15 | 15 | 25 | 25 |
| Optical Properties | | | | |
| Haze, % (Sample Thickness 0.060 in.) | 4.1 | 3.8 | 2.7 | 3.1 |
| Haze, % (Sample Thickness 0.100 in.) | 6.3 | 6.0 | 4.4 | 5.1 |
| Transparency, % (Sample Thickness | 85.1 | 85.3 | 88.0 | 87.2 |
| 0.060 in.) | | | | |
| Transparency, % (Sample Thickness | 81.2 | 81.4 | 82.4 | 80.2 |
| 0.100 in.) | | | | |
| Physical Properties | | | | |
| Vicat Softening Point, ° F. (° C.) | 214 (101.1) | 212 (100) | 201 (93.9) | 202 (94.4) |
| Rockwell Hardness “L Scale” | 22 | 24 | 24 | 15 |
| Specific Gravity | 1.03 | 1.03 | 1.01 | 1.01 |
| Injection Molded Properties | | | | |
| Mechanical Properties | | | | |
| Yield Tensile Strength, psi (MPa) | 5220 (36.0) | 5420 (37.4) | 3250 (22.4) | 3300 (22.8) |
| Ultimate Tensile Strength, psi (MPa) | 3720 (22.5) | 5330 (36.8) | 2840 (19.6) | 2670 (18.4) |
| Ultimate Elongation, % | 9 | 3 | 237 | 253 |
| Tensile Modulus, psi (MPa) | 327,000 | 320,000 | 250,000 | 247,000 |
| | (2,255) | (2,206) | (1,724) | (1,703) |
| Flexural Modulus, psi (MPa) | 369,000 | 376,000 | 269,000 | 257,000 |
| | (2,544) | (2,593) | (1,855) | (1,772) |
| Flexural Strength, psi (MPa) | 9580 (66.1) | 9930 (68.5) | 5820 (40.1) | 5530 (38.1) |
| Notched Izod @ 73° F. (23° C.), ft-lb/in | 0.4 (21.4) | 0.3 (16.0) | 0.6 (32.0) | 0.5 (26.7) |
| (J/m) | | | | |
| Notched Izod @ 0°F. (−18° C.), ft-lb/in | 0.4 (21.4) | 0.3 (16.0) | 0.4 (21.4) | 0.3 (16.0) |
| (J/m) | | | | |
| Thermal Properties | | | | |
| DTUL @ 264 psi, ° F. (° C.) | 166 (74.4) | 163 (72.8) | 151 (66.1) | 155 (68.3) |

As can be seen from the results in Table 6, examples 21 versus 20 and examples 23 versus 22, blends containing SIS-1 give similar results to blends containing SBS-1.

### EXAMPLES 24-25

In the examples in Tables 8 and 9, the physical properties of a blend of K-RESIN, general purpose polystyrene and a styrene-butadiene-styrene triblock copolymer (SB-1/PS-1/SBS-1) (52.5/35.5/12.2 weight percent) were compared to a similar blend containing a styrene-isoprene-styrene triblock copolymer (SB-1/PS-1/SIS-1) in a regrind study. The study was conducted as follows: a 45 kg sample was extrusion compounded, an approximately 6 kg sample was collected. This was repeated until four samples, at passes 1, 3, 5, and 7, each having been successively passed through the extruder an additional time, were collected. The dry blended products (i.e., examples 2 and 3) were prepared by mixing in a tumble blender and extrusion melt blended on a Werner Pfleiderer ZSK-30 twin-screw laboratory extruder. The product was strand pelletized with a Conair Jetro pelletizer. Subsequent to compounding, each product was injection molded on a Mannesman Demag 100 ton molder equipped with a seven-cavity, ASTM-specified family mold.

Properties of the formed products included haze and transparency. The haze and transparency values were determined with a Hunter Lab Tristimulus Colorimeter Model D25P-9 with glass test standard numbered 425 in accordance with ASTM Method D1003-92.

The general extrusion compounding and injection molding conditions are shown in Table 7.

The physical properties of example number 24 are set forth in Table 8 below.

The physical properties of example number 25 are set forth in Table 9 below.

Extrusion Compounding/Injection Molding Conditions

| PROPERTY | Extrusion | Injection |
|---|---|---|
| Zone 1, ° C. | 140 | 160 |
| Zone 2, ° C. | 160 | 175 |
| Zone 3, ° C. | 170 | 175 |
| Zone 4, ° C. | 180 | 175 |
| Die, ° C. | 190 | 175 |
| Melt Temp., ° C. | 200-205 | 210-230 |
| Screw Speed, Rpm's | 200 | 120 |
| Torque, % | 75-85 | NA |
| Injection Speed, sec. | NA | 1.4 |
| Pressure, Mpa | 5.2-14.5* | 4.7-12.4** |
| Cycle Time, sec. | NA | 45 |
| Rate, kg/hr. | 14 | NA |
| Mold Temp., ° C. | NA | 45 |

*Die
**Hydraulic

TABLE 8

| Blend Components | Example No. | | | |
|---|---|---|---|---|
| (Wt. Percent) | 24 | | | |
| Dexco DPX 507 (SBS-1) | 12.2 | | | |
| General Purpose Polystyrene (PS-1) | 35.5 | | | |
| K-RESIN KR05 (SB-1) | 52.5 | | | |
| Butadiene Rubber from SBS-1, Wt. % | 6.83 | | | |
| Butadiene Rubber from SB-1, Wt. % | 13.12 | | | |
| Total Rubber | 19.95 | | | |
| Optical Properties | Pass #1 | Pass #3 | Pass #5 | Pass #7 |
| Haze, % (Sample Thickness 0.060 in.) | 5.2 | 6.3 | 8.5 | 10.5 |
| Haze, % (Sample Thickness 0.100 in.) | 7.6 | 9.3 | 11.8 | 13.3 |
| Transparency, % (Sample Thickness | 83.7 | 82.4 | 83.1 | 82.7 |
| 0.060 in.) | | | | |
| Transparency, % (Sample Thickness | 79.8 | 77.7 | 78.3 | 77.8 |
| 0.100 in.) | | | | |
| Physical Properties | | | | |
| Melt flow Rate, (200° C./5 kg) | 10.5 | 11.0 | 11.1 | 11.2 |
| Vicat Softening Point, ° F. (° C.) | 209 (98.3) | 208 (97.8) | 209 (98.3) | 209 (98.3) |
| Rockwell Hardness “L Scale” | 25.2 | 19.8 | 20.2 | 21.3 |
| Specific Gravity | 1.018 | 1.020 | 1.016 | 1.008 |
| Injection Molded Properties | | | | |
| Mechanical Properties | | | | |
| Yield Tensile Strength, psi (MPa) | 3900 (24.1) | 3790 (26.1) | 3780 (26.1) | 3860 (26.6) |
| Ultimate Tensile Strength, psi (MPa) | 3140 (21.7) | 3070 (21.2) | 3150 (21.7) | 3120 (21.5) |
| Ultimate Elongation, % | 232 | 221 | 232 | 226 |
| Tensile Modulus, psi (MPa) | 273,000 | 274,000 | 273,000 | 271,000 |
| | (1,882) | (1,889) | (1,882) | (1,869) |
| Flexural Modulus, psi (MPa) | 307,000 | 305,000 | 294,000 | 294,000 |
| | (2,117) | (2,103) | (2,027) | (2,027) |
| Flexural Strength, psi (MPa) | 7010 (48.3) | 6990 (48.2) | 6880 (47.4) | 6960 (48.0) |
| Notched Izod @ 73° F. (23° C.), ft-lb/in | 0.5 (26.7) | 0.6 (32.0) | 0.7 (37.4) | 0.7 (37.4) |
| (J/m) | | | | |
| Thermal Properties | | | | |
| DTUL @ 264 psi, ° F. (° C.) | 156 (68.9) | 154 (67.8) | 150 (65.6) | 151 (66.1) |

TABLE 9

| Blend Components | Example No. | | | |
|---|---|---|---|---|
| (Wt. Percent) | 25 | | | |
| VECTOR 4411 (SIS-1) | 12.2 | | | |
| General Purpose Polystyrene (PS-1) | 35.5 | | | |
| K-RESIN KR05 (SB-1) | 52.5 | | | |
| Isoprene Rubber from SIS-1, Wt. % | 6.83 | | | |
| Butadiene Rubber from SB-1, Wt. % | 13.12 | | | |
| Total Rubber | 19.95 | | | |
| Optical Properties | Cycle #1 | Cycle #3 | Cycle #5 | Cycle #7 |
| Haze, % (Sample Thickness 0.060 in.) | 5.1 | 4.4 | 4.8 | 4.9 |
| Haze, % (Sample Thickness 0.100 in.) | 7.6 | 7.5 | 7.5 | 7.4 |
| Transparency, % (Sample Thickness | 83.5 | 83.4 | 83.0 | 82.7 |
| 0.060 in.) | | | | |
| Transparency, % (Sample Thickness | 79.5 | 79.2 | 78.8 | 78.4 |
| 0.100 in.) | | | | |
| Physical Properties | | | | |
| Melt flow Rate, (200° C./5 kg) | 11.3 | 12.1 | 12.7 | 13.2 |
| Vicat Softening Point, ° F. (° C.) | 209 (98.3) | 210 (98.9) | 210 (98.9) | 210 (98.9) |
| Rockwell Hardness “L Scale” | 22.9 | 21.6 | 20.8 | 21.9 |
| Specific Gravity | 1.018 | 1.014 | 1.017 | 1.020 |
| Injection Molded Properties | | | | |
| Mechanical Properties | | | | |
| Yield Tensile Strength, psi (MPa) | 4090 (28.2) | 4140 (28.5) | 4150 (28.6) | 4130 (28.5) |
| Ultimate Tensile Strength, psi (MPa) | 2960 (20.4) | 2920 (20.1) | 2960 (20.4) | 2950 (20.3) |
| Ultimate Elongation, % | 236 | 209 | 217 | 215 |
| Tensile Modulus, psi (MPa) | 275,000 | 277,000 | 281,000 | 272,000 |
| | (1,896) | (1,910) | (1,937) | (1,875) |
| Flexural Modulus, psi (MPa) | 299,000 | 288,000 | 303,000 | 314,000 |
| | (2,062) | (1.985) | (2,089) | (2,165) |
| Flexural Strength, psi (MPa) | 6990 (48.2) | 6910 (47.6) | 7070 (48.7) | 720 (49.6) |
| Notched Izod @ 73° F. (23° C.), ft-lb/in | 0.5 (26.7) | 0.5 (26.7) | 0.5 (26.7) | 0.5 (26.7) |
| (J/m) | | | | |
| Thermal Properties | | | | |
| DTUL @ 264 psi, ° F. (° C.) | 155 (68.3) | 153 (67.2) | 155 (68.3) | 157 (69.4) |

As can be seen from the results in Table 8, example 24 containing SBS-1 shows a significant increase in percent haze with each successive pass through the extruder. This results in a product that is less clear with each successive pass through the extruder.

As can be seen from the results in Table 9, example 25 containing SIS-1 shows a significant increase in melt flow rate with each successive pass through the extruder. This results in a product with improved processing characteristics with each pass through the extruder. In addition, the most unique finding is the percent haze remains constant with each successive pass through the extruder.

In comparing the performance of examples 24 and 25, the results show the blend containing the SIS-1 to be advantage based on the virtually constant percent haze values with each successive pass through the extruder Blends containing SIS-1 show a similar transparency to blends containing SBS-1 with each successive pass through the extruder.

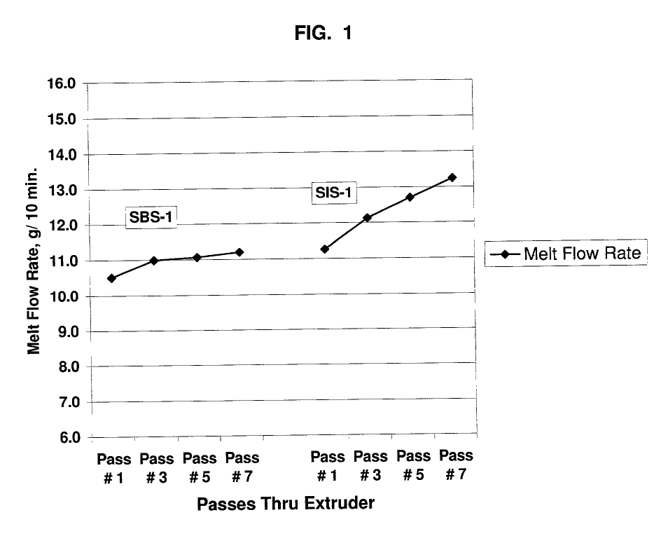

FIG. 1 is a graph of the melt flow rate of the two blends, examples 24 and 25, one containing a styrene-butadiene-styrene triblock copolymer (SBS-1) and one containing a styrene-isoprene-styrene triblock copolymer (SIS-1) versus the number of passes through an extruder. It shows the melt flow rate of example 24, the blend containing SBS-1, demonstrates a similar melt flow rate with each successive pass through the extruder. The blend, example 25 shows an increase in melt flow rate for each successive pass through the extruder.

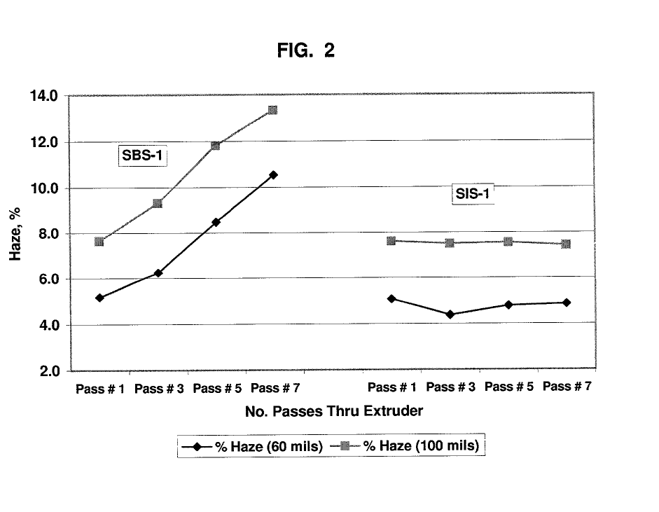

FIG. 2 is a graph of the percent haze of the two blends, examples 24 and 25, one containing a styrene-butadiene-styrene triblock copolymer (SBS-1) and one containing a styrene-isoprene-styrene triblock copolymer (SIS-1) versus the number of passes through an extruder. It shows the percent haze for example 24 to increase significantly, ˜100% for a 0.060 inch and 0.100 inch thick samples, for each successive pass through the extruder. The blend, example 25 shows no increase in percent haze for each successive pass through the extruder.

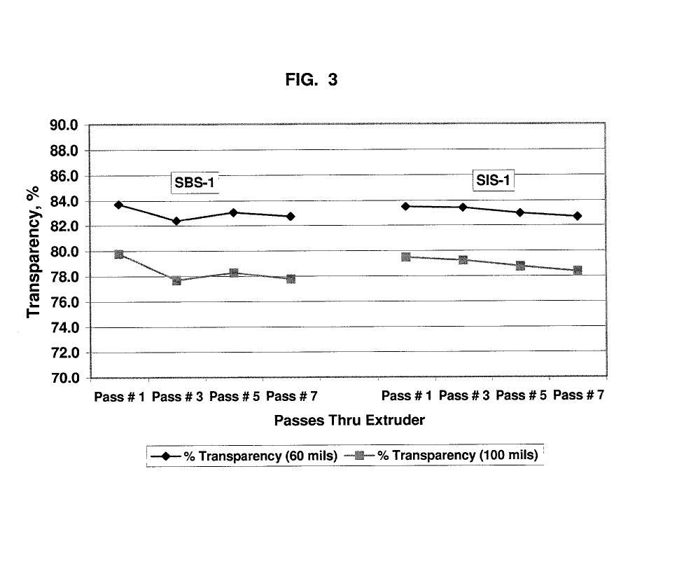

FIG. 3 is a graph of the percent transparency of two blends, examples 24 and 25, one containing a styrene-butadiene-styrene triblock copolymer (SBS-1) and one containing styrene-isoprene-styrene triblock copolymer (SIS-1) versus the number of passes through an extruder. It shows the percent transparency for examples 24 and 25 to be similar for a 0.060 inch and 0.100 inch thick sample, for each successive pass through the extruder.

What is claimed is:

1. A transparent thermoformable polymer blend comprising:
A) from 9 to 90 parts by weight of a monovinyl aromatic-conjugated diene copolymer having a weight average molecular weight (Mw) from 50,000 to 400,000;
B) from 9 to 90 parts by weight of a monovinylidene aromatic polymer having a weight average molecular weight (Mw) from 50,000 to 400,000; and
C) from 1 to 60 parts by weight of a styrene-isoprene-styrene triblock copolymer having a weight average molecular weight of from about 40,000 to about 150,000 wherein the styrene content is from about 25 to 60 weight percent of the total polymer, and the sum of A), B) and C) being 100 parts.

2. A transparent thermoformable polymer blend of claim 1 which comprises from 15 to 75 parts by weight of component A), from 15 to 75 parts by weight of component B), and from 3 to 40 parts by weight of component C).

3. A transparent thermoformable polymer blend of claim 2 wherein the styrene content of the styrene-isoprene-styrene triblock copolymer is from 25 to 55 percent by weight.

4. A transparent thermoformable polymer blend of claim 3 wherein the styrene-isoprene-styrene triblock copolymer has a weight average molecular weight of from about 50,000 to about 150,000.

5. A transparent thermoformable polymer blend of claim 1 wherein the monovinyl aromatic-conjugated diene copolymer of component A) further comprises a polymerized styrene and polybutadiene and wherein the monovinylidene aromatic polymer of Component B) further comprises polystyrene.

6. A process for preparing a transparent polymeric article which comprises:
A) contacting a virgin polymer blend with a recycled polymer blend to form a homogeneous blend wherein the polymer blends independently comprise (1) from 9 to 90 parts by weight of a monovinyl aromatic-conjugated diene copolymer having a weight average molecular weight (Mw) from 50,000 to 400,000 (2) from 9 to 90 parts by weight of a monovinylidene aromatic polymer having a weight average molecular weight (Mw) from 50,000 to 400,000; and (3) from 1 to 60 parts by weight of a styrene-isoprene-styrene triblock copolymer having a weight average molecular weight of from about 40,000 to about 150,000 wherein the styrene content is from about 25 to 60 weight percent of the total polymer, and the sum of A), B) and C) being 100 parts;
B) forming an article from the combined composition; and
C) recycling scrap material generated during the step of forming the article or subsequent processing steps;
wherein the recycled composition contains polymer blend which has been recycled at least five times; and the percent haze value of the combined composition is within 25 percent, as determined pursuant to ASTM D1003 of the virgin polymer blend.

7. The process of claim 6 wherein the formed article is sheet.

8. The process of claim 6 which further comprises thermoforming the sheet into a desired shape.

9. The process of claim 6 wherein the formed article is film.

10. The process of claim 6 wherein the formed article is an injection molded article.

11. The process of claim 6 wherein the monovinyl aromatic-conjugated diene copolymer of component A) further comprises a polymerized styrene and polybutadiene and wherein the monovinylidene aromatic polymer of component B) further comprises polystyrene.

12. A process for preparing a transparent polymeric article which comprises:
A) forming an article from a recycled composition comprising (1) from 9 to 90 parts by weight of a monovinyl aromatic-conjugated diene copolymer having a weight average molecular weight (Mw) from 50,000 to 400,000 (2) from 9 to 90 parts by weight of a monovinylidene aromatic polymer having a weight average molecular weight (Mw) from 50,000 to 400,000; and (3) from 1 to 60 parts by weight of a styrene-isoprene-styrene triblock copolymer having a weight average molecular weight of from about 40,000 to about 150,000 wherein the styrene content is from about 25 to 60 weight percent of the total polymer, and the sum of A), B) and C) being 100 parts; and
B) recycling scrap material generated during the step of forming the article or subsequent processing steps;
wherein the recycled composition contains polymer which had been recycled at least five times; and the percent haze of the combined composition is within 25 percent of the virgin polymer blend determined pursuant to ASTM D1003.

13. An article prepared by the process which comprises:
A) contacting a virgin polymer blend with a recycled polymer blend to form a homogeneous blend;
B) forming an article from the combined composition: and
C) recycling scrap material generated during the step of forming an article or subsequent processing steps:
wherein the virgin polymer blend and the recycled polymer blend comprise
a) from 9 to 90 parts by weight of a monovinyl aromatic-conjugated diene copolymer having a weight average molecular weight (Mw) from 50,000 to 400,000;
b) from 9 to 90 parts by weight of a monovinylidene aromatic polymer having a weight average molecular weight (Mw) from 50,000 to 400,000; and
c) from 1 to 60 parts by weight of a styrene-isoprene-styrene triblock copolymer having a weight average molecular weight of from about 40,000 to about 150,000 wherein the styrene content is from about 25 to 60 weight percent of the total polymer, and the sum of A), B) and C) being 100 parts;
wherein the recycled composition contains polymer blend which has been recycled at least five times; and the percent haze value of the combined composition is within 25 percent, as determined pursuant to ASTM D1003, of the virgin polymer blend.

14. The article prepared by the process of claim 13 wherein the article is a sheet wherein the process further comprises thermoforming the sheet into a desired shape, removing unwanted polymeric scrap material and recycling polymeric scrap material.

15. The article of claim 13 wherein the monovinyl aromatic-conjugated diene copolymer of component A) further comprises a polymerized styrene and polybutadiene and wherein the monovinylidene aromatic polymer of component B) further comprises polystyrene.

16. The article of claim 13 wherein component C) of the virgin composition, the recycled composition or a combined composition thereof further comprises up to about 40% by weight of a styrene-butadiene-styrene block copolymer having a molecular weight having a molecular weight of from about 50,000 Dalton to about 100,000 Dalton and a styrene content of from about 25 weight percent to about 50 weight percent.
